(19) United States
(12) Patent Application Publication
(10) Pub. No.: US 2002/0101851 A1
(43) Pub. Date: Aug. 1, 2002

(54) Method of and apparatus for providing multiple independent voice telephone line circuits using and including a packet voice device

(76) Inventors: John D. Blake JR., Edgewater, MD (US); Myron E. Harper, Burtonsville, MD (US); Stephen D. Martin, Millersville, MD (US)

Correspondence Address: Leonard C. Suchyta, c/o Christian R. Andersen, Verizon Services Group, 600 Hidden Ridge Drive - HQE03H01, Irving, TX, 75038, US

(21) Appl. No.: 09/725,156

(22) Filed: Nov. 29, 2000

(51) Int. Cl. H04L 12/66

(52) U.S. Cl. 370/352; 370/437

(57) ABSTRACT

A system and method overlay of advanced digital technology onto the installed feeder and distribution cable portion of the outside plant to obtain additional voice circuits. Interface equipment proximate existing drop wire interface points converts digitized voice circuits back to analog signaling together with appropriate POTS signaling and power connections. The interface equipment is centrally powered along with other portions of the outside plant so that operation is independent of customer and commercial power sources. Power may be provided by batteries located at the associated central office or by locally provisioned, non-interruptible, battery-backed-up power sources. The existing switched telephone network includes central offices connected by interoffice facility trunks, each central office providing service to nearby subscribers connected by local loop facilities. These local loop facilities include a feeder/distribution system connecting the central offices to respective serving area interfaces and local drops connecting respective subscriber to the serving area interfaces. The capabilities of the feeder/distribution facilities are enhanced and expanded to accommodate additional subscribers by (re) configuring the feeder/distribution system to provide multiple digital subscriber lines between the central offices and the serving area interfaces or terminals using respective digital subscriber line circuits. The digital subscriber line circuits are terminated at respective Packet Voice Devices located at remote DSLAM terminals serving SAIs or mounted at serving terminals; and subscriber lines are assigned to individual channels of each of the digital subscriber line circuits.

### TECHNICAL FIELD

The present invention relates to switched telephone networks and, more particularly, to providing multiple telephone circuits over existing local loop facilities.

### ACRONYMS

The written description uses a large number of acronyms to refer to various services and system components. Although generally known, use of several of these acronyms is not strictly standardized in the art. For purposes of this discussion, acronyms therefore will be defined as follows:

| | |
|---|---|
| ADM | Add/Drop Multiplexer |
| ADSL | Asymmetric Digital Subscriber Line |
| AIN | Advanced Intelligent Network |
| ATM | Asynchronous Transfer Mode |
| BRI | Basic Rate Interface (ISDN) |
| CBR | Constant Bit Rate |
| CCIS | Common Channel Interoffice Signaling |
| CCS | Common Channel Signaling |
| CEV | Controlled Environmental Vault |
| CLEC | Competitive Local Exchange Carrier |
| CO | Central Office |
| COT | Central Office Terminal |
| DA | Distribution Area |
| DAML | Digital Added Main Line |
| DLC | Digital Loop Carrier |
| DLEC | Data Local Exchange Carrier |
| DS1 | Digital Signal 1 = 1.544 Mb/sec |
| DSL | Digital Subscriber Line |
| DSLAM | Digital Subscriber Line Access Multiplexer |
| DSX | Digital Signal Crossconnect |
| ESS | Electronic Switching Systems |
| FDF | Fiber Distribution Frame |
| FTE | Fiber Terminating Equipment |
| GR-303 | Generic Requirement - 303 - Digital Concentration |
| HDSL | High Speed Digital Subscriber Line |
| IAD | Integrated Access Device |
| ILEC | Incumbent Local Exchange Carrier |
| IOF | InterOffice Facilities |
| IP | Internet Protocol |
| ISDN | Integrated Services Digital Network |
| ISP | Internet Service Provider |
| LEC | Local Exchange Carrier |
| MDF | Main Distribution Frame |
| MPEG | Motion Picture Experts Group |
| NGDLC | Next Generation DLC |
| NGN | Next Generation Network |
| NGS | Next Generation Switch |
| NID | Network Interface Device |
| POTS | Plain Old Telephone Service of System |
| PRI | Primary Rate Interface |
| PSTN | Public Switched Telephone Network |
| PVD | Packet Voice Device |
| RDT | Remote Digital Terminal (NGDLC) |
| SAC | Serving Area Concept |
| SAI | Serving Area Interface |
| SCP | Service Control Point |
| SDSL | Synchronous Digital Subscriber Line |
| SM | Switch Module |
| SNI | Subscriber Network Interface |
| SPC | Stored Program Control |
| SSP | Service Switching Point |
| STP | Signal Transfer Point |
| SVG | Switched Voice Gateway |
| TR-08 | Technical Requirement 08 - Digital |
| TR-57 | Technical Requirement 57 - Analog |
| UBR | Unspecified Bit Rate |
| VBR | Variable Bit Rate |
| WC | Wire Center |

### BACKGROUND ART

Since its inception, the Public Switched Telephone Network (PSTN) has continuously expanded and adopted new and improved technology to provide critical and essential telephone services to its subscribers. The PSTN had evolved from a manual switchboard based Central Office (CO) to crossbar switches and then Electronic Switching Systems (ESS) with Stored Program Control (SPC). Current digital switches (also known as Service Switching Points or SSPs) such as the #5ESS manufactured by Lucent Technologies and the DMS 100 manufactured by Northern Telecom, Inc. include out-of-band signaling capabilities using a Common Channel Signaling (CCS) or Common Channel Interoffice Signaling (CCIS) such as SS7. This signaling network provides packet data communications between and among the switches via routers called Signal Transfer Points (STPs). In addition to logic stored in each of the digital switches, the SSPs may obtain call processing and routing instructions from other platforms via the signaling network. These platforms typically include a Service Control Point (SCP) providing a centralized database used to determine call routing for such services as 800 service. Additional functions may also be incorporated at these centralized facilities such as the Telcordia ISCP. Augmenting or centralizing switching and routing logic is the basis of an Advanced Intelligent Network (AIN.) Such systems are described in the prior art literature and patents including, for example, U.S. Pat. No. 5,923,659 to Curry, et al. issued Jul. 13, 1999 entitled “Telecommunications network” and U.S. Pat. No 6,069,890 to White, et al. issued May 30, 2000 entitled “Internet telephone service”, both of which are incorporated herein by reference in their entirety.

While switching capabilities of the PSTN may be upgraded by the installation of CO equipment, upgrading connectivity with subscribers, i.e., the local loop, involves the costly addition and/or replacement of embedded outside plant facilities including millions of miles of cables connecting subscribers to CO switches and transmission facilities. Conventionally, the outside plant was designed according to a Serving Area Concept (SAC) plan in which a wire center is divided into an appropriate number of Distribution Areas (DA) handled by one or more local CO switches. Each DA serves approximately 300 to 900 access lines relative to the density and demographics of the area being served.

There are six main component parts of the traditional local loop. The initial component connected to the CO equipment is the feeder cable, usually a 3600 pair copper cable designed to serve multiple DAs. The Feeder Cable connects the CO to the next component, the Serving Area Interface (SAI). The SAI is a cross-connect point designed to optimize feeder facilities while providing flexibility for the DA which it serves. This is achieved by developing a ratio of feeder facilities (F1) to distribution facilities (F2), usually 1.5 (F1 pairs) to 2-3 (F2 ) pairs. The Distribution (or F2) cable is a smaller version of feeder cable, having a smaller number of twisted pair wires and terminating at a Distribution Cable Termination or terminal. A drop wire inter-connect device or terminal may be located aerially, in a pedestal, at a building entrance or in a manhole. The terminal is used to connect the drop wire to a Subscriber Network Interface (SNI, also known as a Network Interface Device or NID) and is the demarcation point between the Local Exchange Carrier (LEC) and a subscriber. Expansion of the local loop to serve additional communities or additional subscribers in communities already served would therefore require the addition of this extensive infrastructure of metallic cables, cross connects and interfaces from the CO to the subscribers.

To avoid installation and attendant maintenance issues of large feeder cables, integrated, optical Digital Loop Carrier (DLC) or Next Generation Digital Loop Carrier (NGDLC) systems were developed and deployed as a substitute or to replace aging copper loop infrastructure. Typical systems such as the Alcatel Litespan-2000 can serve up to 2,016 lines of conventional residential telephone service (i.e., Plain Old Telephone Service or POTS). The DLC/NGDLC system interfaces to the CO switch at one end via an Add-Drop Multiplexer/Central Office Terminal (ADM/COT) and provides line side connections at a SAI via a Remote Digital Terminal. Thus, while the system eliminates or avoids the installation of large copper feeder cables, it relies on the installation of new or on existing copper distribution cables and drop wires for the “last mile” of connectivity to the subscriber premises. Further, DLC/NGDLC systems still require the installation of high bandwidth optical cable from the CO facilities to the Remote Digital Terminal. Such new installations may be expensive and time consuming, requiring substantial planning, new equipment, obtaining appropriate rights-of-way and construction permits, building of new facilities for the installation of equipment, provision of power, etc. In addition, DLC/NGDLC systems may not be compatible with other services as explained below.

From a cost and time basis, therefore, there is considerable impetus to avoid the premature retirement of existing local loop facilities, with an emphasis on the development and deployment of technology to extend the useful of life of the existing embedded loop facilities. For example, the use of Integrated Services Digital Network (ISDN) lines provides digital connectivity between switching centers and subscriber premises. The Basic Rate Interface (BRI) includes two 64 Kb/s data channels (referred to as “B” channels) and one 16 Kb/s signaling channel (called the “D” channel. Thus BRI is also sometimes referred to as 2B+D.) Each B channel can be considered a separate line. Therefore you can simultaneously download a file at 64 Kb/s on one channel and talk to a friend on the other B channel. It is also possible to use both B channels together to get a total bandwidth of 128 Kb/s. Primary Rate Interface (PRI) service includes 23 B channels, and one 64 Kb/s D channel (also referred to as 23B+D). Each B channel can be run separately (twenty-three 64 Kb/s connections) or can be used together to get approx. 1.5 Mbps, or any combination thereof. While BRI service may use existing copper loop facilities, PRI still needs wideband conditioning and connectivity capable of transporting T1 or DS1 service.

Another approach to extending the outside plant facilities uses advanced modulation techniques to enhance the bandwidth of twisted pair facilities. These Digital Subscriber Line (DSL) technologies were originally developed to provide Motion Picture Experts Group (MPEG)-encoded video programming from a video programming source to subscribers. Since this required a wide “downstream” channel from the CO facilities to the subscriber, but only limited “upstream” control data requirements, the technology offered an asymmetric channel capability termed ADSL or Asymmetric Digital Subscriber Line service. ADSL, as other variants of DSL (generically xDSL including ADSL, HDSL, SDSL and others) use loop frequency above standard POTS requirements. Thus, standard POTS is allocated to the 300-3000 Hz frequencies, DSL to the frequencies above those, while battery and ringing occupies the lower end of the frequency range of 20 Hz. and below.

Several proposals have been made to utilize the broadband capability of DSL to support multiple voice circuits. See, for example, CopperCom, Mastering Voice over DSL: Network Architecture (1999) and CopperCom, Complete DSL: Requirements for Public Multi-Line Telephone Service Delivery over the DSL Access Network (1999), both of which publications are incorporated herein by reference in their entirety. While the proposed architectures address multiline service with data to a particular subscriber by including appropriate DSL equipment on site at the customer premises, the proposals do not address incorporating appropriate systems into the existing local loop environment so as to transparently and seamlessly provide POTS equivalent service to multiple subscriber locations.

Accordingly, a need exists for a system for and method of extending the useful life of existing telephone local loop facilities. A further need exists for expanding the number of lines supported by existing local loop facilities without requiring installation of new or additional cables. A still further need exists for a system for and method of providing POTS equivalent service to existing and new subscribers without replacing or the addition of new feeder or distribution cable or drop wire facilities and without modification to existing Serving Area Interfaces (SAIs) and terminals.

### DISCLOSURE OF THE INVENTION

The present invention overcomes the above noted problems by providing systems and call processing methodologies that extend the useful life of existing telephone local loop facilities without requiring new or modifications to existing customer provided equipment or other subscriber facilities. The invention overlays advanced digital technology onto the installed feeder and distribution cable portion of the outside plant to obtain additional voice circuits. Interface equipment proximate existing drop wire inter-connect points and converts digitized voice circuits back to analog signaling together with appropriate POTS signaling and power connections. The interface equipment is centrally powered along with other portions of the outside plant so that operation is independent of customer and commercial power sources. Power may be provided by batteries located at the associated central office or by locally provisioned, non-interruptible, battery-backed-up power sources.

A method according to the invention provides voice grade telephone service to multiple subscribers using existing telephone loop facilities. The method includes configuring the telephone line facilities to provide Digital Subscriber Line (DSL) technology between a telephone facility and a remote facility providing voice grade services. Subscriber lines are assigned to each of the DSL channels and calls terminating at a CO are routed to the associated DSL channels. The DSL channels are used to transmit the calls to respective packet voice devices (PVDs) located at the remote facility. Calls are then completed or extended from the PVDs to nearby subscribers over respective copper loop facilities connecting the PVDs to telephone equipment of the subscribers.

According to a feature of the invention, power is supplied to the PVDs independent of a local commercial power source. The power source may be located at a CO facility or within the distribution plant. DSLs may be installed at offsite locations near respective groups of the subscribers being served by the DSLs such as at one or more SAIs or distribution cable interface ends. In the latter case, opposite ends of the drop wires are connected to subscriber network interface devices (NIDs) located on the premises of respective ones of the subscribers.

According to another aspect of the invention, an existing switched telephone network includes COs connected by interoffice facility trunks, each CO providing service to nearby subscribers connected by local loop facilities. These local loop facilities include a feeder/distribution system connecting the COs to respective SAIs and local drops connecting respective subscriber to the SAIs. The invention expands or extends the capabilities of the feeder distribution to accommodate additional subscribers by (re)configuring the feeder distribution system to provide multiple DSLs between the COs and the SAIs using respective DSL circuits. The DSL circuits are terminated at respective PVDs located at Digital Subscriber Line Access Multiplexers (DSLAMs); and subscriber lines are assigned to each of the DSL circuits. Incoming calls to subscribers terminating at a CO are routed to an associated one of the DSL circuits and transmitted to respective PVDs located at the remote facility. The voice calls are then completed from the PVDs to nearby called subscribers over respective copper loop facilities connecting the PVDs to telephone equipment of the called subscribers. Conversely, outgoing calls placed by a customer are initiated by detection of an off-hook condition present on one of the local drops. Dial tone (or some other form of signaling) indicating that a dialed digit register or equivalent is available and is transmitted from the CO to the local drop via an associated one of the DSL circuits. The called number is provided by collecting dialed digits at the CO. The dialed digits are. received from the local loop and transmitted to the CO by way of the associated one of the DSL circuits. Once collected, the dialed digits are used to complete a voice call to a telephone line corresponding to the telephone number. (Although the term voice call has been used, it is understood to include other forms of switched telephone service including typical analog POTS voice and data carried in the voice band or channel.) The telephone number may be transmitted by in-band signaling using the associated one of the DSL circuits so as to establish a full-duplex voice circuit also using the associated one of the DSL circuits.

According to another aspect of the invention, a telephone system includes network switching facilities having (i) a voice or packet switch providing telephone service to a plurality of subscribers, and (ii) a digital subscriber line access multiplexer (DSLAM) connected to the voice or packet switch. The telephone system also includes local loop transmission facilities connected to the DSLAM. A PVD is connected (a) to the DSLAM via the local loop transmission facilities and (b) to a plurality of copper loops, each of the copper loops terminated at a respective network interface devices (NIDs) associated with respective subscribers for providing voice telephone service to the subscribers. A power supply may be connected to the local loop transmission facilities to supply electric operating power to the PVD.

According to a feature of the invention, the voice or packet switch includes (i) a digital interface connected to the DSLAM, and (ii) a plurality of line cards connected to provide telephone service to another plurality of subscribers. The network switching facilities may also include a main distribution frame (MDF) connected to the local loop transmission facilities to transmit signals (i) between the DSLAM and the copper loop transmission facilities and (ii) between the line cards and other copper loop facilities associated with other plurality of subscribers. The DSLAM may be connected to the voice switch by way of a switch voice gateway.

According to another feature of the invention, the PVD may include a weatherproof outdoor enclosure having mounted in the enclosure multiple line modules connected to corresponding copper loops, each of the copper loops extending and connecting to a corresponding one of the subscribers. The enclosure may then be installed in the field proximate the subscriber premises, e.g., houses, apartments, businesses, etc. (e.g., on a nearby utility pole).

According to another feature of the invention, the telephone system includes a main distribution frame and multiline protector block connecting to the copper loops. A digital loop carrier (DLC/NGDLC) system may be connected to and share the fiber optic cable used by the DSLAM. The network switching facilities further including an optical Add-Drop Multiplexer/Central Office Terminal (ADM/COT) and a digital cross connect configured to connect the DLC/NGDLC to the voice switch. Both or either of the DSLAM and PVD may be supplied with uninterrupted, battery back-up power independent of a commercial power source providing power to the subscribers. The PVD may be provisioned and mounted in a number of appropriate locations and equipment facilities within the distribution plant including (i) a serving area interface cabinet and (ii) a distribution cable termination site or terminal, where it is connected to a plurality of subscriber network interfaces (NIDs )via respective drop wires.

According to another feature of the invention, the voice switch includes a switch module (SM) including a plurality of analog POTS line cards having associated therewith ones of the subscribers.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF DRAWINGS

FIG. 1 is a block diagram of a switched telephone network including traditional twisted copper pair, Digital Loop Carrier (DLC)/Next Generation Digital Loop Carrier (NGDLC) and Digital Subscriber Line (DSL) supported voice grade plain old telephone service (POTS).

FIG. 2 is a block diagram of a switched telephone system providing voice grade service with a central office (CO) located digital subscriber line access multiplexer (DSLAM) with a pole mounted Packet Voice Device (PVD).

FIG. 3 is a block diagram of a switched telephone network providing voice grade service with a CO based DSLAM with collocated PVD shelf.

FIG. 4 is a block diagram of a switched telephone network providing voice grade service with a remote DSLAM and pole mounted PVD.

FIG. 5 is a block diagram of a switched telephone network providing voice grade service using a remotely located DSLAM with collocated PVD for providing a derived voice channel over a twisted copper loop.

FIG. 6 is a block diagram of remote DSLAM configuration with collocated PVDs for providing 8-64 Kb/s uncompressed voice lines per PVD.

FIG. 7 is a block diagram of a CO resident DSLAM with collocated PVDs interfacing to a Network Access Service Hub (N.A.S.H.) office including a next generation switch.

FIG. 8 is a diagram depicting DSLAM line cards interfacing an OC3c to groups of 48 twisted pair local loops.

### BEST MODE FOR CARRYING OUT THE INVENTION

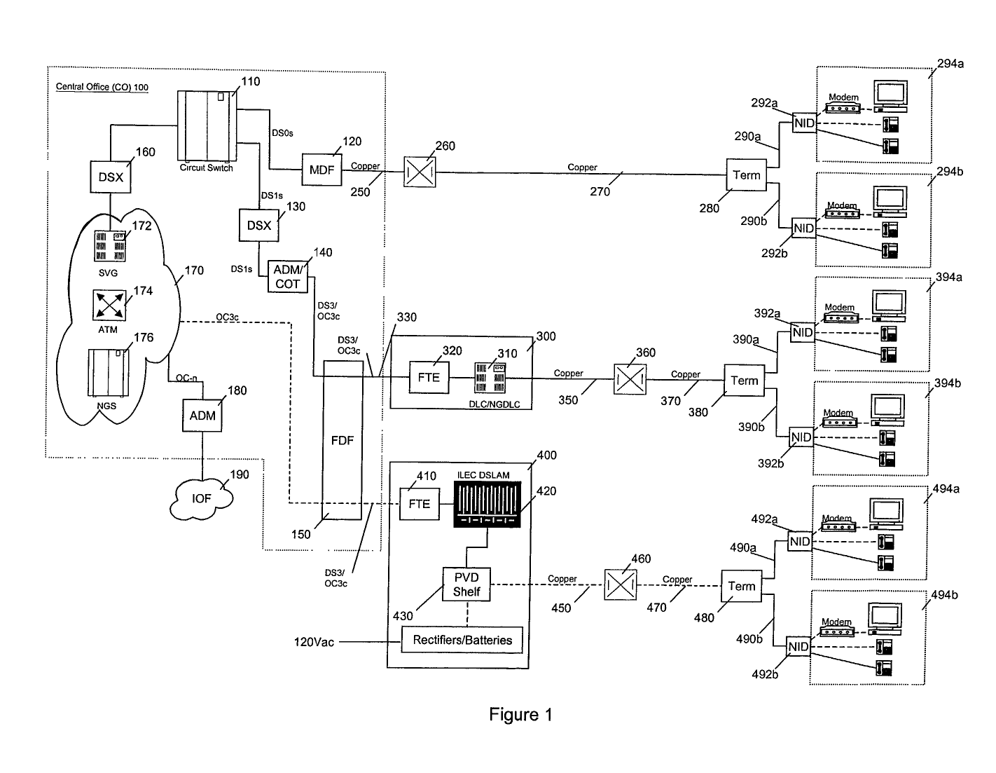

Referring to FIG. 1, a central office (CO) 100 includes a circuit switch 110 complying with conventional voice switch technical and generic requirements, such as TR57/TR08/GR-303, the Lucent Technologies 5E, or Nortel DMS 100 switches. Conventionally, circuit switch 110 includes line cards providing service to multiple DS0 type lines through a main distribution frame (MDF) 120, part of the distribution facilities supporting circuit switch 110. MDF 120 interfaces the switching facilities with the outside plant. Thus, MDF 120 terminates typically hundreds or thousands of twisted pair circuits connecting multiple serving area interfaces (SAI) 260s of the outside plant. Although only one SAI 260 is shown, typically one SAI provides service for 300 to 1200 lines and is therefore located in respective neighborhoods of the area served by CO 100. The SAI is a cross-connect box connecting an F1 or main feed cable 250 to multiple F2 or copper distribution cables 270 that may be located on utility poles above ground, buried below ground, or housed in a suitable panel box such as in an apartment building. The distribution cables 270 connect to terminals 280 near individual customer premises by respective drop wires 290a and 290b and network interface devices (NIDs) 292a and 292b. As shown, each of the customer premises is provided with two voice telephone lines, one dedicated to a telephone set, the other shared between a conventional telephone and a data modem and associated computer terminal.

A Digital Loop Carrier/Next Generation Digital Loop Carrier (DLC/NGDLC) system provides a second architecture for supporting switched voice circuits. Circuit switch 110 connects to digital signal cross connect (DSX) 130 on an appropriate number of digital signal i.e., (DS1) connections. In turn, DSX 130 is connected to ADM/COT 140 which combines the DS1s into a DS3 or OC3 connection to fiber terminating equipment (FTE) 320 via fiber distribution frame (FDF) 150. FTE 320 is located at a remote site such as a controlled environmental vault (CEV) 300. FTE 320 connects the DS3/OC3 output from ADMICOT 140 to DLC/NGDLC system 310 which operates to interface the multiplexed optical traffic to individual twisted copper pairs 350 connecting to SAI 360 provisioned in the neighborhood or locality served by the respective telephone lines. SAI 360 is, in turn, connected by F2 copper distribution cables 370 (e.g., copper cables and twisted pairs) to appropriate local terminal devices 380 located near the individual customer premises. Terminals 380 are connected by respective drop wires 390A and 390B and NIDs 392A and 392B to respective customer premises 394A and 394B.

A third architecture for providing additional voice telephone lines is based on digital subscriber line (DSL) technology. Circuit switch 110 is connected to Digital Signal Cross-connect (DSX) 160 providing connectivity to next generation network (NGN) 170. NGN 170 may include, for example, a switched voiced gateway (SVG) 172, A synchronous Transfer Mode (ATM) switch 174 and/or Next.

Generation Switch (NGS) 176 and similar digital and packet based switching and routing systems.

Thus, NGN 170 connects via various optical carrier networks and digital protocols to ADM 180 and appropriate interoffice facilities (IOF) 190. NGN 170 also provides OC3c connectivity via FDF 150 to FTE 410 and digital subscriber line access multiplexer (DSLAM) 420, both located at a remote location such as CEV 400. DSLAM 420 serves as a packet concentrator, delivering traffic from multiple packet voice devices (PVDs) mounted in PVD shelf 430 and multiple customers over the high-speed OC3c link to NGN 170 and circuit switch 110. DSLAMS and associated IADs (PVDs) may be obtained from commercial sources such as, for example, CopperCom, Inc., Cisco Systems, Inc. XEL Communications, Inc., Jetstream Communications, Inc., Alcatel, Copper Mountain, Lucent, Paradyne, and others. Each PVD card of PVD shelf 430 will support up to 48 individual telephone Circuits or more over corresponding twisted pair copper telephone lines. Thus, PVD shelf 430 may support the typical 300-1200 lines handled by SAI 460, providing service via smaller F2 copper distribution cables 470 to terminals 480 near customer premises 494a and 494b. In effect, DSLAM 420 in combination with PVD shelf 430 provide a “back door” access to circuit switch 110 via NGN 170 so that additional voice grade telephone service over conventional plain old telephone service (POTS) lines may be provided to support customer requirements and to extend the useful life of the copper plant and switching equipment. Power to DLC/NGDLC and DSLAM systems in CEV 400 is provided by commercial AC power to rectifiers and batteries which provide non-interuptable battery back-up supply to the systems in the event of a commercial power outage.

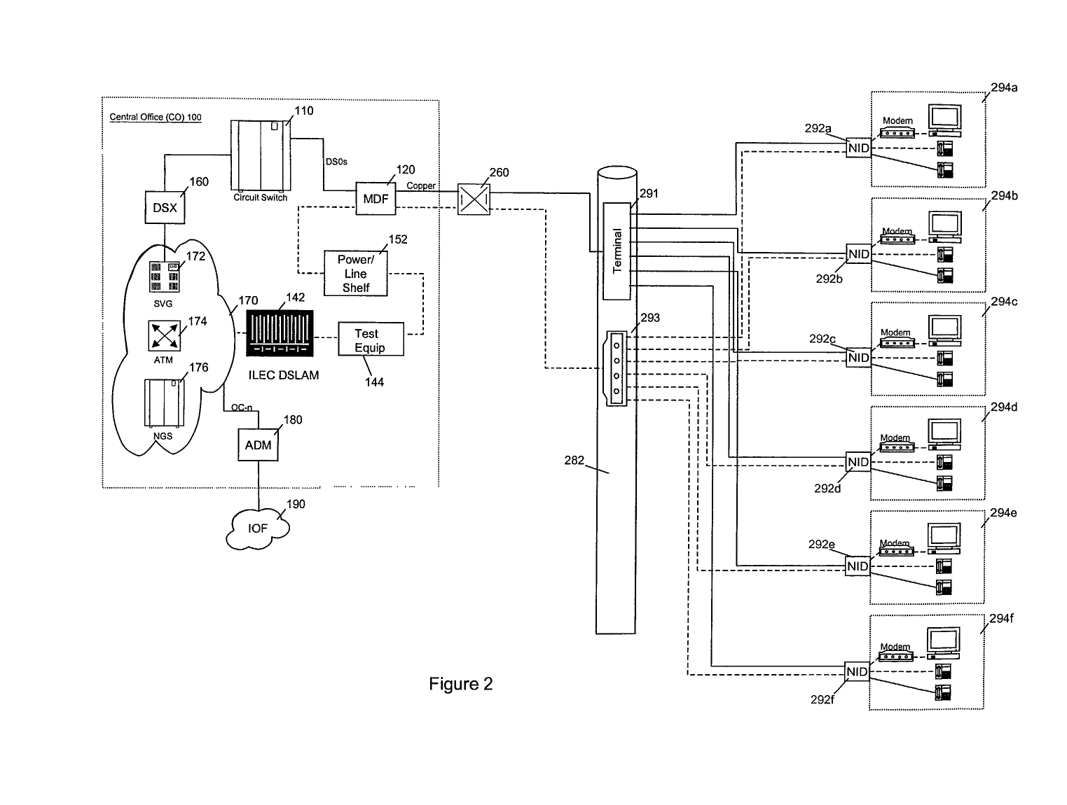

FIG. 2 is a block diagram of a switch telephone network for providing voice-only POTS telephone lines to a plurality of subscribers as a second line, primary service continuing to be provided using conventional POTS circuit cards and equipment. Thus, a “front door” connection to circuit switch 110 is provided by conventional POTS circuit cards providing respective DS0s on twisted pair at main distribution frame (MDF) 120. MFD 120 interfaces the switching facilities with the outside plant. Hundreds or thousands of twisted pair circuits connect multiple SAIs 260 for further distribution via an F1 or multiple F2 copper distribution cables to terminals 291 located in the general vicinity of groups of subscribers. As shown in FIG. 2, terminal 291 is co-located with a remote PVD 293 on a utility pole 282. Of course, although the terminal 291 and PVD 293 are shown in an above-ground environment, other facilities including buried pedestals or building terminals may be used instead. As will be explained, PVD 293 provides second line service to subscribers at residences 294a-294f using a “back door” connection and access to circuit switch 110 to expand the POTS capabilities of the switching facilities.

Referring to FIG. 2 of the drawings, CO 100 includes DSLAM 142 connected to NGN 170 for providing a back door access to circuit switch 110 via DSX 160. DSLAM 142 is connected through DSL testing and maintenance equipment 142. Thus, the DSL circuits from DSLAM 142 are then routed to a power/line shelf 152 which provides appropriate DC power for remote equipment including utility pole mounted PVD 293 via MDF 120 and intermediate SAI 260. Power/line shelf 152 thus provides power and battery backup for remote equipment to ensure uninterrupted POTS service over DSL even when local power is out. PVD 293, mounted on utility pole 282 in the vicinity of customer premises 294a-294f (powered by DC power provided by power/line shelf 152) functions to convert the DSL channels into standard POTS signaling to be provided over local drops to respective network interface devices (NIDs) 292a-292f at the respective customer premises. At each of the customer premises 294a-294f, a primary telephone is supported by standard copper circuit based POTS while a second telephone line including a second telephone and a modem and computer terminal are supported by the DSL provisioned circuits. In case of loss of power, all required circuitry and systems are powered by the CO including, for example, in the case of the copper based POTS circuits, battery and ringing, and in the case of DSL-based systems, power to PVD 293. In addition, PVD 293 provides standard POTS loop current and signaling to the associated local drops supporting customer premises 294a-294f.

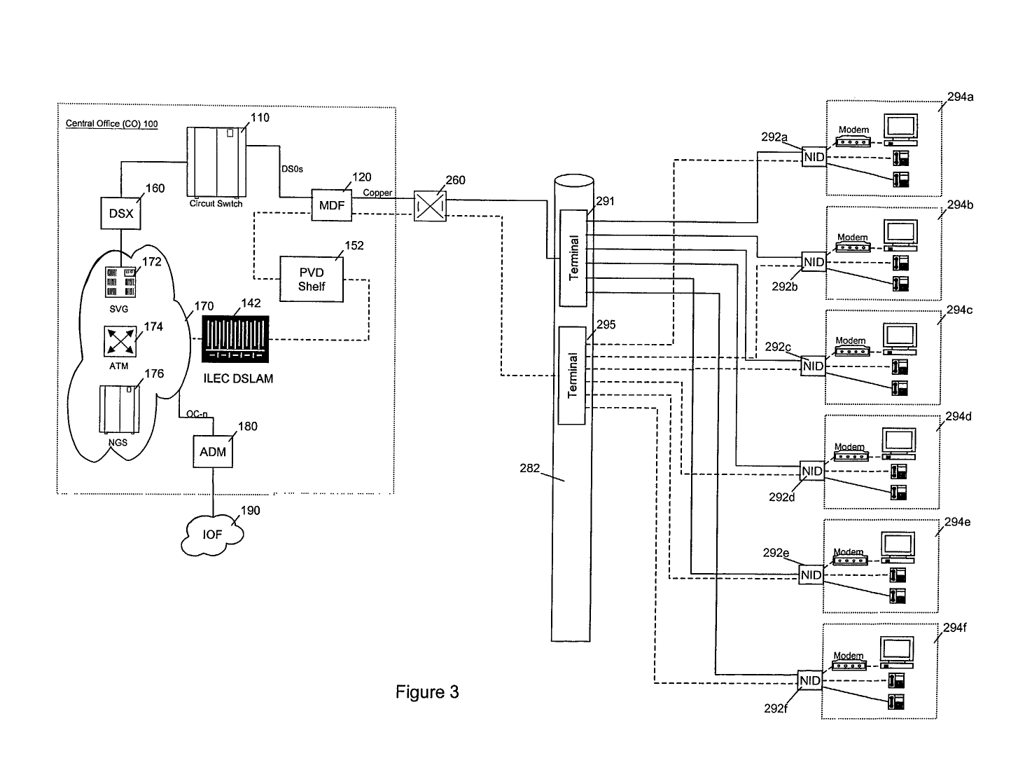

FIG. 3 is a block diagram of still an alternate configuration for supplying second line voice grade service to customer premises 294a-294f using DSL to expand the capability of circuit switch 110. Thus, as described in connection with FIG. 2, DSLAM 142 provides a back door into switch 110. However, unlike the configuration of FIG. 2, all PVDs are installed at CO 100 in PVD shelf 152 to convert the DSL into standard POTS lines. All telephone lines egressing CO 100 via MDF120 appear to the distribution system as standard POTS, while a portion represented by the dotted line are, in actuality, converted from DSL-based circuits. This provides additional capability for circuit switch 110 which could not otherwise be supported by provisioning of additional POTS line cards to provide the required DSOs, particularly in the second line situation. Since this second line capability is supplied at the CO as standard copper-based POTS, a second terminal 295 is included on pole 282 to provide a second grouping of drops for the associated customer premises 294a-294f.

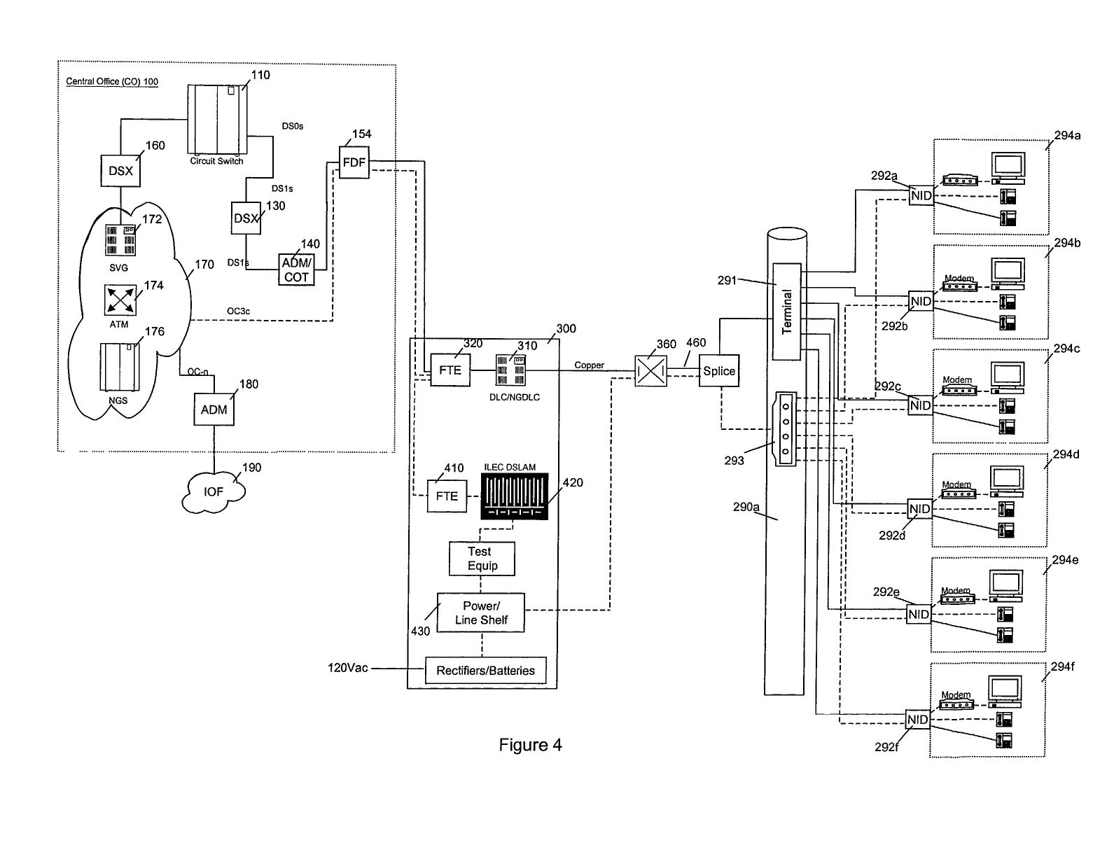

FIG. 4 illustrates another configuration using both Digital Loop Carrier/Next Generation Digital Loop Carrier (DLC)/NGDLC to extend the local loop into the field and DSL to add additional line capability, not otherwise supported by switch 110 of CO 100. Thus, a conventional DLC/NGDLC interface to switch 110 includes a DSX 130 for connecting multiple DS1s from switch 110 to ADM/COT 140, which are then routed to FDF 154. In turn, these DS1s are supplied to a DLC/NGDLC system 310 via fiber terminating equipment 320 at, for example, a CEV 300. DLC/NGDLC 310 converts the digital voice channels into standard POTS, which is then distributed via SAI 360 to terminal 291 and customer premises 294a-294f.

Referring to FIG. 4, second line capability is again supported by DSL, a remote DSLAM 420 included in a remote location such as CEV 300. DSLAM 420 interfaces via FTE 410 and FDF 154 to NGN 170 as previously described. DSL related power and test equipment including power/line shelf 430 and 440 are included in the CEV together with the remote DSLAM equipment 420. DSL circuits are then routed through SAI 360 to PVD 293 mounted on utility pole 290a via F2 cable 460. POTS lines are then distributed to customers 294a-294f via drop wires to NIDs 292a-292f.

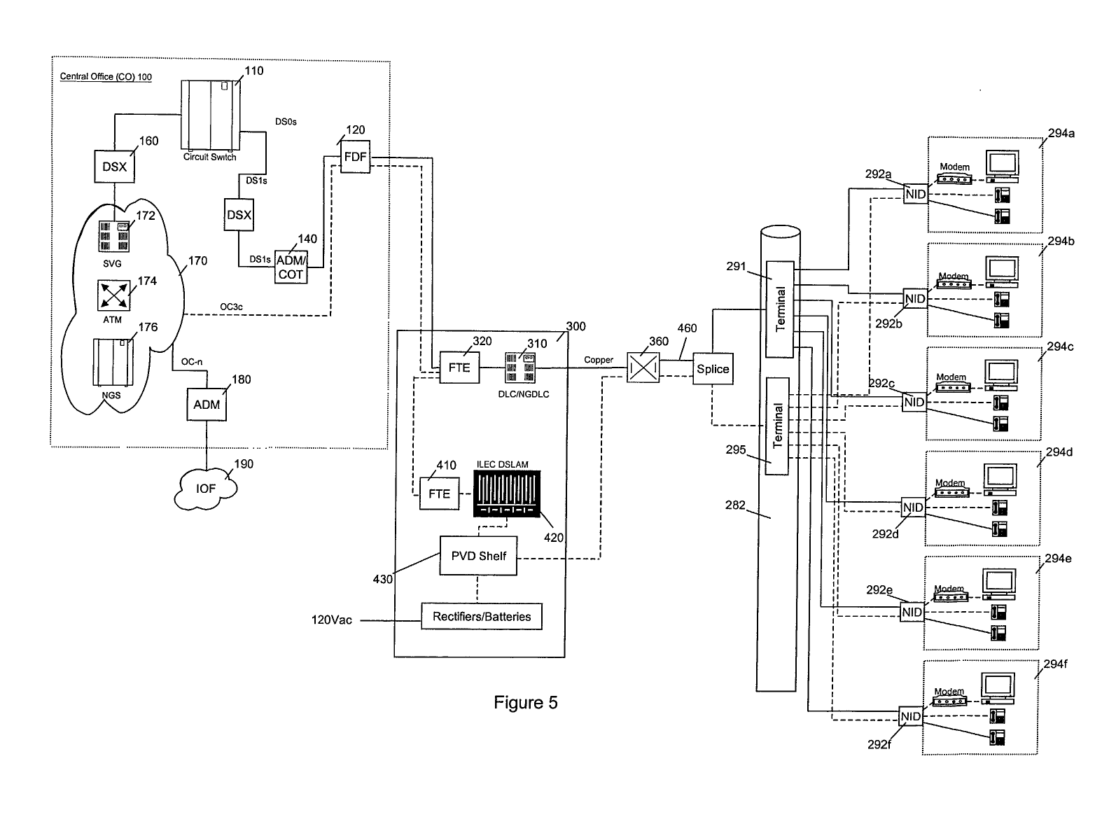

Referring to configuration of FIG. 5, the DSLAM equipment is located in CEV 300 together with DLC/NGDLC 310 similar to FIG. 4. Instead of a power/line shelf in FIG. 4 to support PVD 293 on utility pole 290a, FIG. 5 interfaces DSLAM 420 to PVD shelf 430 to convert DSL circuits to POTS lines for distribution. Power to DLC/NGDLC and DSLAMs may be supplied by batteries or some other non-interruptible power source so that second line capability is maintained even in a power outage situation, a feature considered important to standard POTS. Respective DSL channels carrying POTS lines are then transported to SAI 360 where they are cross-connected to distribution cable 460 and transported to new terminal 295 at utility pole 282. Distribution to respective customer premises 294a-294f is as previously described via two pairs of twisted copper wires connecting respective customer NIDS 292a-292f to terminal 291 and new terminal 295.

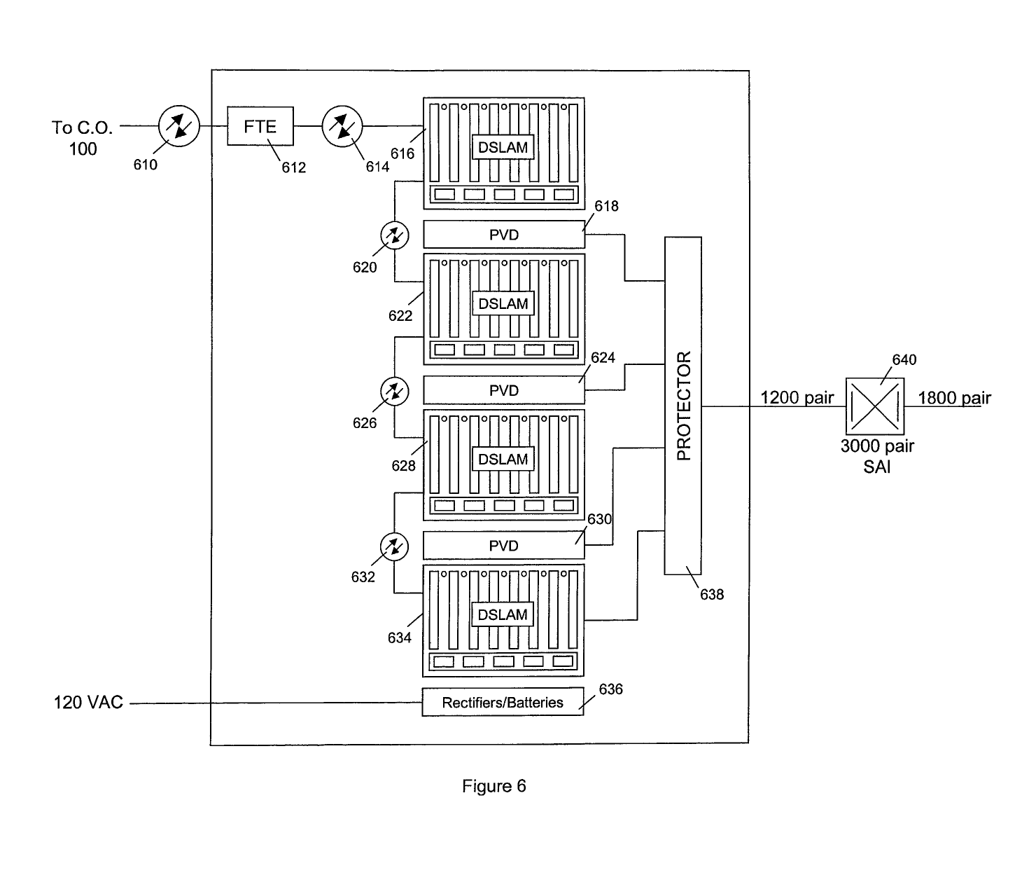

FIG. 6 shows a configuration of remote DSLAMS for, this case, providing a full 1200 POTS lines. Because each DSLAM and associated PVD shelf can provide a maximum of 384 POTS lines, a fourth DSLAM is installed to provide multi-channel POTS capability to individual subscribers as required to complete the full 1200 pairs.

Referring to FIG. 6, connectivity with CO 100 is provided by OC3c connection 610 to FTE 612 and, via OC3c 614 to a first DSLAM 616. DSLAM 616 is then connected in tandem with DSLAM 622 via OC3c 620, DSLAM 628 via OC3c 626 and DSLAM 634 via OC3c 632. PVD shelves 618, 624, and 630, associated with respective DSLAMs 616, 622, and 628, interface via backplane wiring and are interfaced to protector block 638 to SAI 640 to provide a total of 1152 line pairs. The remaining 48 line pairs are individual DSLAM circuits capable of carrying multiple POTS lines are provided directly by DSLAM s. DSLAM 634 likewise is connected via protector 638 to complete the suite of 1200 line pairs supplied to SAI 640. A power supply including rectifier/battery 636 provides a non-interruptible power source to the equipment and appropriate loop current and signaling power.

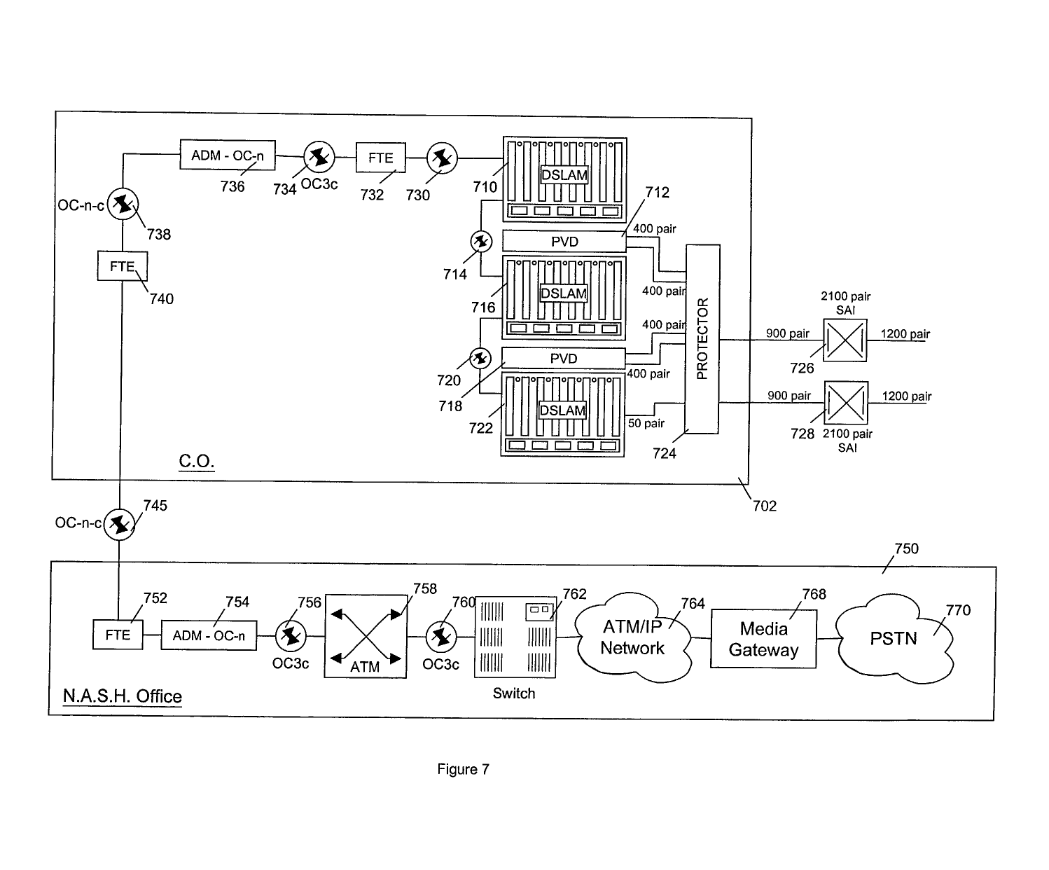

FIG. 7 shows a configuration of a CO-based DSLAM with PVDs interconnected to a Network Access Service Hub (N.A.S.H.) office. N.A.S.H. office 750 provides a centralized architecture to support local POTS services from a remote switch to the PSTN. FTE 752 is connected to ADM 754 and to ATM 758 via OC3c 756. In turn, ATM 758 is connected via a second OC3c connection 760 to a next generation switch 762 and thence to an ATM/IP network 764. ATM/IP network 764 is in turn connected to a media gateway 768 and, via the gateway, to PSTN 770.

CO 702 is connected via Ocn-c (i.e., OC3c or OC48c) to FTE 752 of N.A.S.H. office 750. Thus, Ocn-c 738 provides connectivity to ADM 736 and, via FTE 732 to tandemly connected DSLAM 710, 716 and 722. Because the configuration assumes compressed voice lines, each of the PVDs can support 16 compressed voice lines as opposed to eight non-compressed voice lines.

Accordingly, each PVD shelf 712 and 718 can support approximately 800 POTS lines, which are provided via protector 728 and SAI 726 and 728 to the distribution system. DSLAM 722 provides 48 individual DSL circuits to individual customers with multi-channel requirements.

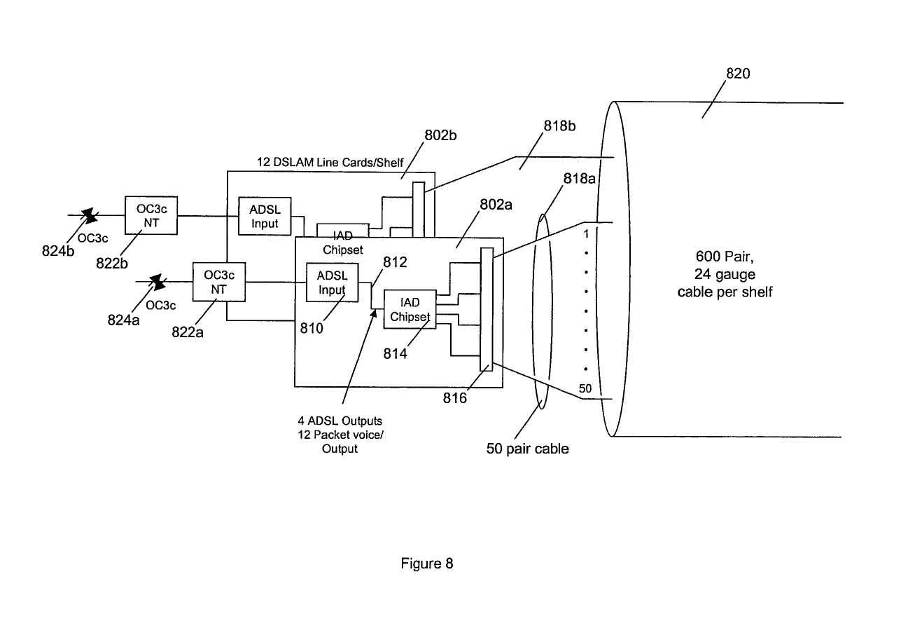

FIG. 8 shows details of connections between each of the DSLAM line cards and the associated copper plant. Thus, OC3c 824a is connected via OC3c NT 822a to a DSLAM line card 802a. Each DSLAM line card 802a includes an asymmetric digital subscriber line (ADSL) input device 810 and an IAD chip set 814. An output of ADSL input device 810 is connected to IAD chipset 814 via a connection 812 including four ADSL outputs. In turn, IAD chipset 814 is connected to 50 pairs of a 600-pair, 24-gauge cable 820 connecting the line cards to an associated SAI via any required MDF protectors or other related circuitry.

While this invention has been described in connection with what is presently considered to be the preferred embodiment, it is to be understood that the invention is not limited to the disclosed embodiment, but, on the contrary, is intended to cover various modifications and equivalent arrangements included within the spirit and scope of the appended claims. It should further be noted and understood that all publications, patents and patent applications mentioned in this specification are indicative of the level of skill of those skilled in the art to which the invention pertains. All publications, patents and patent applications are herein incorporated by reference to the same extent as if each individual publication patent or patent application was specifically and individually indicated to be incorporated by reference in its entirety.

What is claimed is:

1. A method of providing voice grade telephone service to a plurality of subscribers using existing telephone loop facilities, comprising the steps of:
configuring said telephone loop facilities to provide plural digital subscriber line (DSL) services between a telephone facility and a remote facility using respective DSL circuits;
assigning a plurality of subscriber lines to each of said DSL circuits;
routing calls terminating at a central office to an associated one of said DSL circuits;
transmitting calls on said DSL circuits to respective Packet Voice Devices (PVDs) located at said remote facility;
completing calls from said PVDs to nearby ones of said subscribers over respective copper loop facilities connecting said PVDs to telephone equipment of said subscribers.

2. The method of claim 1 further comprising the step of supplying power to said PVDs independent of a local commercial power source.

3. The method of claim 1 further comprising the step of installing said DSLs at offsite locations near respective groups of said subscribers being served by said DSLs.

4. The method of claim 1 further comprising the step of installing said DSLs at one or more remote DSLAM Terminals, which in turn supply Serving Area Interfaces (SAIs).

5. The method of claim 1 further comprising the step of installing said DSLs at distribution cable interface ends of respective drop wires wherein opposite ends of said drop wires are connected to subscriber network interface devices (NIDs) located on the premises of respective ones of said subscribers.

6. In an existing switched telephone network comprising a plurality of central offices connected by interoffice facility trunks, each central office providing service to nearby subscribers connected by local loop facilities, the local loop facilities including a feeder distribution system connecting the central offices to respective serving area interfaces and local drops connecting respective subscribers to said serving area interfaces, a method of expanding the capabilities of the feeder distribution to accommodate additional subscribers, comprising the steps of:
configuring said feeder/distribution system to provide plural digital subscriber loops (DSL) between said central offices and said serving area interfaces using respective DSL circuits;
terminating said DSL circuits at respective PVDs located at remote DSLAM terminals; and
assigning a plurality of subscriber lines to each of said DSL circuits.

7. The method according to claim 6 further comprising the steps of:
routing calls terminating at a central office to an associated one of said DSL circuits;
transmitting calls on said DSL circuits to respective Packet Voice Devices (PVDs) located at said remote facility;
completing voice calls from said PVDs to nearby ones of said subscribers over respective copper loop facilities connecting said PVDs to telephone equipment of said subscribers.

8. The method according to claim 6 further comprising the steps of:
detecting an off-hook condition present on one of said local drops;
transmitting dial tone from said central office to said local drop via an associated one of said DSL circuits;
collecting dialed digits at said central office, dialed digits received from said local loop and transmitted to said central office by way of said associated one of said DSL circuits; and
completing a voice call to a telephone number corresponding to said dialed digits.

9. The method according to claim 8 wherein said steps of transmitting includes in-band signaling using said associated one of said DSL circuits, and said completing step includes establishing a full-duplex voice circuit also using said associated one of said DSL circuits.

10. A telephone system comprising:
network switching facilities including
(i) a digital switch providing telephone service to a plurality of subscribers,
(ii) a digital subscriber line access multiplexer (DSLAM) connected to said voice switch;
local loop transmission facilities connected to said DSLAM; and
a PVD connected (a) to said DSLAM via said local loop transmission facilities and (b) to a plurality of copper loops, each of said copper loops terminated at respective network interface devices (NIDs) associated with respective ones of said subscribers for providing voice telephone service to said subscribers.

11. The telephone system according to claim 10 wherein said digital switch comprises one of a packet and voice switch.

12. The telephone system according to claim 10, further comprising a power supply connected to said local loop transmission facilities and supplying electric operating power thereover to said PVD.

13. The telephone system according to claim 10 wherein digital switch includes (i) a digital interface connected to said DSLAM, and (ii) a plurality of line cards connected to provide telephone service to another plurality of subscribers.

14. The telephone system according to claim 13 wherein said network switching facilities further include a main distribution frame (MDF) connected to said local loop transmission facilities to transmit signals (i) between said DSLAM an said copper loop transmission facilities and (ii) between said line cards and other copper loop facilities associated with said another plurality of subscribers.

15. The telephone system according to claim 10 further comprising a packet switch connecting said DSLAM to said digital switch.

16. The telephone system according to claim 10 wherein said PVD further comprises a weatherproof outdoor enclosure having mounted therein a plurality of line modules connected to corresponding copper loops, each of said copper loops extending and connecting to a corresponding one of said subscribers.

17. The telephone system according to claim 16 wherein said DSLAM is connected to said digital switch by way of a fiber optic cable.

18. The telephone system according to claim 17 further comprising a main distribution frame and multi-line protector block.

19. The telephone system according to claim 18 further comprising a Digital Loop Carrier (DLC) system connected to and sharing said fiber optic cable, said network switching facilities further including an optical add/drop multiplexer (ADM)/Central Office Terminal (COT) and a digital cross connect configured to connect said DLC to said digital switch.

20. The telephone system according to claim 19 wherein said DSLAM and PVD receive uninterrupted, battery back-up power independent of a commercial power sources providing power to said subscribers.

21. The telephone system according to claim 10 wherein said PVD is mounted at a distribution cable termination site; aerial, buried, underground or building terminal and is connected to a plurality of subscriber network interfaces via respective drop wires.

22. The telephone system according to claim 10 wherein said digital switch includes a switch module (SM) including a plurality of analog POTS line cards having associated therewith ones of said subscribers.
